(19) United States
(12) Patent Application Publication
(10) Pub. No.: US 2005/0057773 A1
(43) Pub. Date: Mar. 17, 2005

(54) Printing images from mobile wireless devices

(76) Inventors: Chris Buck, Surrey (GB); Simon Judge, Surrey (GB); Tom Carnell, Surrey (GB); Mike Stroud, Surrey (GB); Ron Maor, Surrey (GB)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/914,508

(22) Filed: Aug. 10, 2004

(51) Int. Cl. B41B 1/00

(52) U.S. Cl. 358/1.15

(57) ABSTRACT

A method of obtaining printed copies of one or more digital picture files from a mobile wireless device is disclosed. An application may be downloaded to the device from an application server. The application runs on the device to enable the user to select the one or more picture files to be printed, and causes the device to download a list of options from a configuration server. The user selects an option is selected from the list, and the selected picture files are uploaded to a printing server, together with an identification of the selected option. Preferably the selected option is a store selected from a list of stores, and the printed copies may be collected from that store.

### FIELD OF THE INVENTION

The present invention relates to printing digital images. In particular, although not exclusively, the invention relates to printing images obtained using a camera integrated with a mobile wireless device, or cell phone.

Background to the Invention

Many modern cell phones have integrated cameras and display screens, enabling a user to capture an image digitally, and send the image over a wireless network to another user also having a cell phone with a display screen. The digital images are typically low resolution and small, and are frequently viewed once by the recipient and then discarded. It would be desirable for users of such phones to have access to a method for printing out pictures, either those taken by the camera integrated with the phone, or those received from another phone.

One possible method of printing pictures stored in mobile phones involves connecting the phone to a computer attached to a printer, and printing the pictures from there. Alternatively, some phones can be connected directly to printers. Such methods rely on the user having access to a printer of sufficiently high quality to print photographs. Furthermore, they cause inconvenience to the user because most printers available to the home user print images only very slowly, and require specialist paper to produce prints of acceptable quality. Furthermore, the connection between the phone and computer or printer may not be simple to initiate.

Another method which has been suggested is to upload pictures from a cell phone to a service provider's website, typically using the General Packet Radio Service (GPRS) protocol. The user can then download the pictures from the website to his own computer and print them from there, or request a service provider to print them and send them to him. Other users can also view the pictures at the provider's website. However, the user is still required to print the pictures himself or send them off to be printed remotely.

### STATEMENT OF THE INVENTION

It is an object of the present invention to provide a simple procedure by which a cell phone user can obtain prints of digital images stored on his cell phone. It is a further object to provide a procedure by which a user can order prints without uploading images to a website.

The present invention enables the user to order prints of digital images using his cell phone in a single operation.

In accordance with one aspect of the present invention there is provided a method of obtaining a printed copy of one or more digital picture files from a mobile wireless device, comprising:
selecting the one or more picture files to be printed;
downloading a list of options from a configuration server to the device;
selecting an option from the list of options; and
uploading an identification of the selected option and the selected picture files to a printing server.

Thus it is a simple operation for the user to select a printing option and pictures to be printed, and send these to a printing server to be printed by a third party. There is no need to upload the pictures to a website or attempt to print them directly.

In a preferred embodiment the user will already have obtained an application which runs on the device, the application enabling the user to select the one or more picture files, download the list of options and upload the selected picture files to the printing server. This application further simplifies the operation for the user.

The application may be downloaded to the device in response to an initiation message (e.g. an SMS message) from an application server. Preferably the application server is caused to transmit the initiation message in response to contact over the Internet from the user, either from a home computer or a WAP telephone. The user accesses the application server via a website, and requests that the application is installed onto his device. Alternatively, the application may be installed from a PC, for example using Bluetooth or infrared. The application may also be downloaded directly to the device from a third party web site.

Preferably the list of options downloaded to the device from the configuration server includes a list of stores from which the printed copies may be collected. The user can then select a store from the list. The copies may be printed centrally and sent to the store, or printed using apparatus at the selected store. The user can then go to collect the prints. The list of options may also include an option for the prints to be sent directly to an address provided by the user.

Files supplied by the configuration server to the device may be branded so that it appears to the user to be operated by the provider of the stores in the list of stores.

As a further alternative, a prior service application may be downloaded to the device. The service application may operate to download a list of service providers or stores to the device based on the location of the device or the user's address. The location may be entered by the user or obtained automatically. The user can then select a service provider or local store, and brand specific information (e.g. icons, available stores, products and prices, and the printing application referred to above) may then be downloaded to the device. This enables the user to select a store close to his current position or home address to which the prints should be delivered.

It will be appreciated that, although the configuration server, printing server and application server have been defined as three separate entities the functions of all three may be performed by a single computer or server.

Preferably the telephone number of the device is sent to the printing server at the same time as the print files and option identification. Alternatively or in addition, user identification may be sent to the printing server. This enables the printed copies to be assigned to the correct user for ease of collection. In a further alternative, when the application is obtained, the telephone number of the device may be supplied to the application server. An activation code may be supplied to the device at the same time. This activation code is preferably then entered the first time the application is run on the device. In all subsequent communications between the device and any server, the user can be identified from the activation code entered into the application.

A credit limit or account balance may be downloaded to the device from the configuration server and displayed to the user. The user may be prevented from ordering more prints than his credit limit or account balance allows. Alternatively, the user may pay for prints from the device, either using a credit card or via network operator billing.

A confirmation message (e.g. an SMS message) is preferably sent from the printing server to the device to confirm that the one or more picture files have been received by the printing server. Alternatively or in addition, a confirmation message may be sent to the device to confirm that the printed copies are ready for collection from a store.

The step of uploading the picture files and identification of the selected option may be performed using the General Packet Radio Service (GPRS) protocol. Similarly, the application may be downloaded to the device using GPRS. Alternatively, either or both of these steps may be performed using the Universal Mobile Telephony Services (UMTS) protocol developed for use with third generation (3G) phones. In accordance with another aspect of the present invention there is provided a system for providing printed copies of digital picture files stored on mobile wireless devices, the system comprising:
a configuration server for receiving a printing request from a mobile wireless device and providing a list of printing options to the device;
a printing server for receiving one or more picture files from the device together with identification of one option selected from the list of printing options; and
a printing means for printing the one or more picture files in response to an instruction from the printing server.

A user may be required to register before the application is uploaded to the device or at the same time the application is first run. This may be performed either over the internet (before the application is uploaded) or directly from the device (at the same time as the application is run).

### BRIEF DESCRIPTION OF THE DRAWINGS

So that the manner in which the features of the present invention are attained and can be understood in detail, a more particular description of the invention, briefly summarized above, may be had by reference to the appended drawings. It is to be noted, however, that the appended drawings illustrate only typical embodiments of this invention and are therefore not to be considered limiting of its scope, for the invention may admit to other equally effective embodiments.

FIG. 1 is a schematic diagram showing a system for providing printed copies of digital picture files.

FIG. 2 is an overview of modules in a server for ensuring that printed copies of digital picture files are directed to a store for collection.

FIG. 3 is a diagram showing the operation of an application running on a mobile wireless device when ordering printed copies of digital picture files.

FIG. 4 is a schematic diagram showing an alternative system for providing copies of digital picture files.

### DETAILED DESCRIPTION OF THE PREFERRED EMBODIMENT

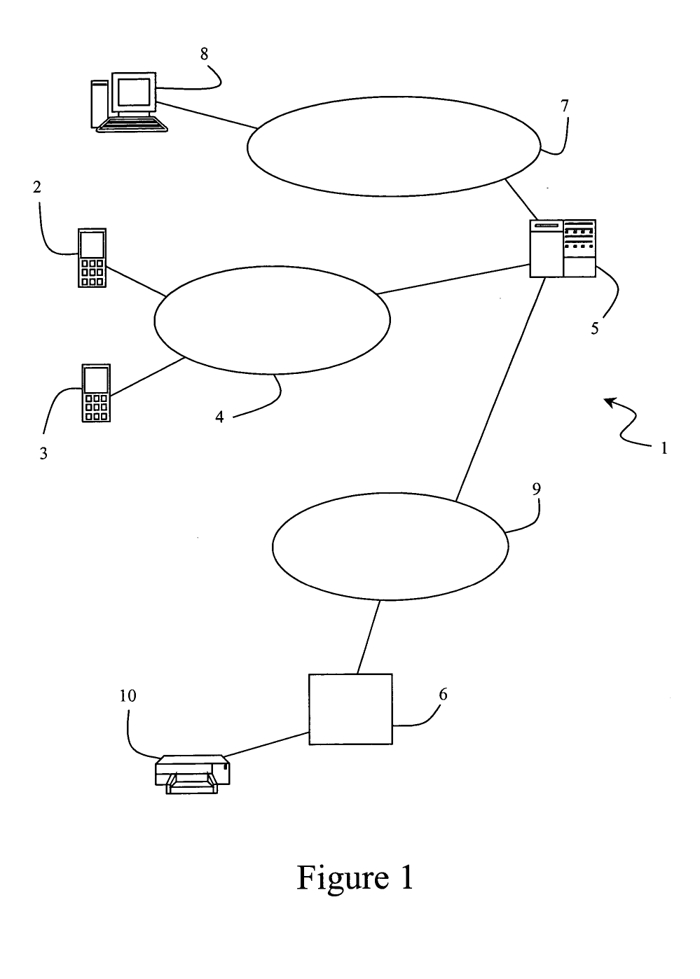

FIG. 1 is a schematic diagram showing a network 1 for obtaining printed copies of digital image files stored on a mobile wireless device such as a cell phone handset equipped with a camera. Two cell phone handsets 2, 3 are connected to a wireless network 4, enabling picture files to be sent between the handsets 2 and 3. The wireless network 4 may be a General Packet Radio Service (GPRS) or Global System of Mobile Communications (GSM) network or a Universal Mobile Telephony Services (UMTS) network, or any other form of wireless network for use with mobile wireless devices.

If the user of the cell phone 2 wishes to print a picture (either taken using his handset 2 or received via the wireless network 4 from the other handset 3) he needs to send the picture file to a print server 5 to print the picture file and leave it at a store 6 in the vicinity of the user for collection.

In order to achieve this, the user needs an application installed on his handset 2. In order to obtain this, the user accesses a website hosted by the print server 5 via the Internet 7, either using the WAP capabilities of his handset 2 or from a home computer 8. The print server sends an SMS message to the handset 2 over the wireless network 4. Upon receipt of the SMS message the handset 2 opens a connection via the wireless network 4 to the print server 5 and downloads and installs the application.

When the application is subsequently run on the handset 2, the user is invited to select images stored on the handset for printing. A connection is then established from the handset 2 to the print server 5 via the wireless network 4. The handset provides service parameters such as its telephone number and the version no. of the application to the print server 5. In response the print server 5 sends to the handset 2 a list of stores 6 from which a printed copy can be collected.

The user selects one of the stores 6 and this information is returned to the print server 5, together with the selected picture files for printing. The print server forwards the picture files, together with an identification of the user, to the selected store 6 via a dedicated network 9. The picture files are printed using a printing apparatus 10 such as a digital minilab at the selected store. The store 6 informs the print server 5 when the printed copies are ready for collection by the user, and an SMS message is sent from the print server 5 to the handset 2 to inform him of this fact. The user then visits the store 6 to collect the prints.

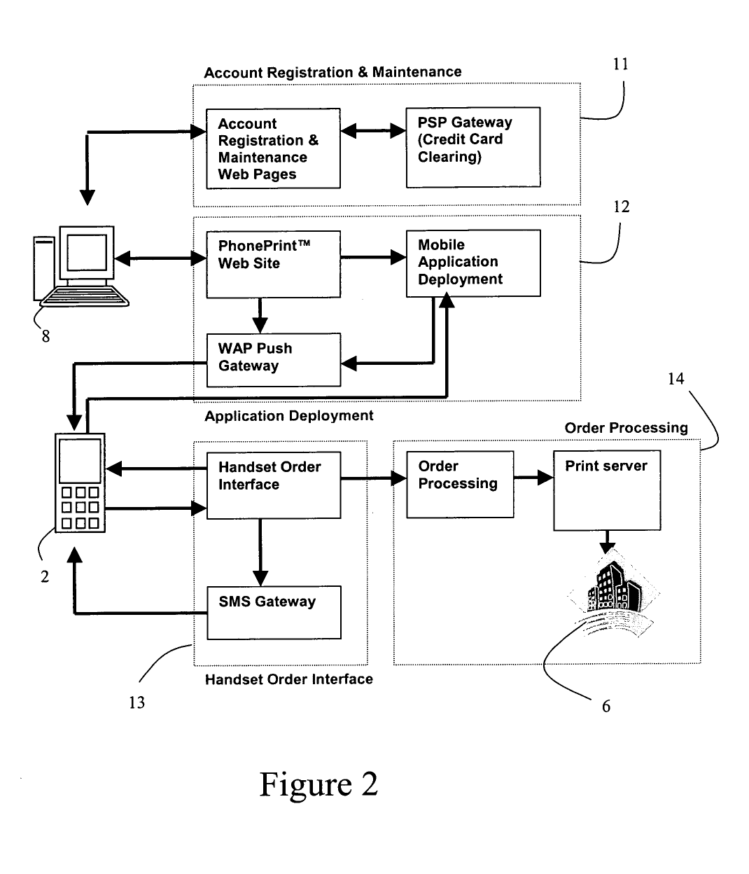

The process will now be described in more detail with reference to FIG. 2, which provides an overview of the modules operated by the print server 5.

An account registration and maintenance module 11 provides web pages, branded by the retailer offering the printing services, which allow users to register, view and maintain an account with the retailer for providing prints. The web pages can be accessed from the user's home computer 8. Depending on the retailer's wishes, account registration may or may not be mandatory before prints are ordered. If account registration is not mandatory, it must be possible for a user to pay for the printing directly when picking up prints from the store 6. For retailers requiring account registration, an account must be registered and in credit before a user can order prints. The account is associated with the telephone number of the handset 2.

The web pages operated by the account registration and maintenance module 11 allow users to credit their account balance via credit card payment. The account balance will be used by the handset 2 to determine how many prints the consumer can order, as described below. The server 5 will debit the account when a subsequent order is uploaded and processed.

A website and application deployment module 12 provides branded web pages advertising the service, providing “How It Works” and “FAQ” links, listing participating stores and allowing consumers to locate and download the application for their phone. The website will include a “download” button which can be operated by a user accessing the website, e.g. from their home computer 8. When the “download” button is pressed the server 5 connects to an SMS Gateway and use a Service Indication (SI) WAP Push message to send a URL to the customer's handset 2 over GSM. On receipt of the Service Indication the handset 2 opens a wireless connection and downloads the application from the print server 5 using the supplied URL. An activation code may also be downloaded to the handset at the same time.

A handset order interface module 13 provides service, customer account, store, product & pricing information to the handset 2. Following installation on the handset 2, the application is run. The first time the application is run the user is prompted for the application code, which is subsequently stored on the handset 2 and sent with all future communications with the print server 5. If the user has not already registered using the Internet, this can now be done directly from the handset the first time the application is run. The user is then invited to select which picture files he wished to print. The application then causes the handset to contact the print server 5.

In the first step of this communication the handset requests service configuration detail using the HTTP GET protocol. As part of this request the handset 2 supplies its telephone number and a service identity, together with an additional version number identifying the version of the application being used, to the server 5.

The server 5 checks the supplied order version against an internal list. If the version is no longer supported the server responds with an error code and message to indicate this, preferably indicating that the user should visit the website included in the application deployment module 12 to obtain the latest version of the application.

If the application version number is supported, the server 5 will respond with a single XML document containing customer account, store, product and pricing information. The service configuration XML content is compact so as to minimise download time across a 32 Kbps connection. Returning all detail in a single document means that the handset 2 does not need to make multiple connection requests across the wireless network 4, which is typically a slow process.

The list of stores 6 from which prints can be collected is gathered by the handset order interface module 13 of the server 5 from a database and returned to the handset 2. Thus when a new store becomes available, that store can be added to the database and will be available immediately to all handset users without additional configuration work.

The user chooses one of the stores from the list using the application running on the handset 2. If pre-paid accounts are used and a registered account is associated with the telephone number provided by the handset 2, the server returns the user's current account balance to the handset 2. If pre-paid accounts are not mandatory and the user is permitted to pay for the prints at the store 6, the server responds with a credit limit for printing at that store. Alternatively, payment could be made using the handset, either using a credit card or network operator billing.

The application running on the handset checks that the prints selected for printing will not cost more than the credit in the user's account (if used) or the credit limit for a selected store. The handset 2 then uploads order data to the server 5 in two (or more) passes. First a small amount of order data is sent to the server, preferably in the form of an XML document. The server validates the content to check that all expected fields are supplied and that service, store and product codes are valid. After this the handset 2 uploads the images to be printed one at a time. This ensures that there is no need for the handset 2 to perform any zipping or packing of the image files.

On receipt of all order data and image files, the server 5 sends an SMS confirmation message back to the originating handset 2. This information is sent via an SMS Gateway. The SMS is branded so that it appears to originate from the retailer operating the stores 6 from which the prints are collected, and confirms receipt of the order and how long it will take before the prints are ready for collection.

Once all order data and images have been uploaded to the server 5, the order is forwarded by an order processing module 14 to the selected store 6 for printing.

It will be noted that the user does not enter personal information into the handset 2 when ordering prints, and that only the originating telephone number is uploaded in the order sent to the server 5. The name of the customer is thus not directly available to the server 5. For systems in which account registration is mandatory, the server searches an account database, using the user's telephone number, and retrieves the registered user's name. These details will be inserted into the order sent to the store 6. This will be useful for operations and reporting and more importantly means that the user's name will appear on any labels printed in the store, aiding their identification when collected by the user.

As mentioned earlier, at the point when the user downloads the application from the server 5, he is provided with an activation code. The user's telephone number and identification details are provided to the server 5 at the same stage. The first time the user runs the application he enters the activation code. Subsequent queries to the server 5 send the activation code, from which the server can identify the user information previously provided.

The name of users who have not registered an account will never be known and therefore will not arrive at the store. This means that the prints can only be identified in the store from the user's telephone number or the order number.

As soon as the order upload is complete the server immediately debits the order value from the customer's account balance (if used). The account is identified using the originating telephone number.

The resolution of camera phones is currently poor (a typical handset records 640×480 pixels—i.e. 0.3 megapixel, although camera phones with higher resolution are available), so the maximum realistic print size is 4×3″. However, typical photographic printing labs are set up so that the lowest size that they can print is 6×4″. Therefore it is simplest to arrange two 4×3″ pictures for printing on a single 6×4″ piece of paper. This is done before the files are assembled and downloaded from the server 5 to the store 6. However, the user may be given a choice as to the form he wishes his prints to take.

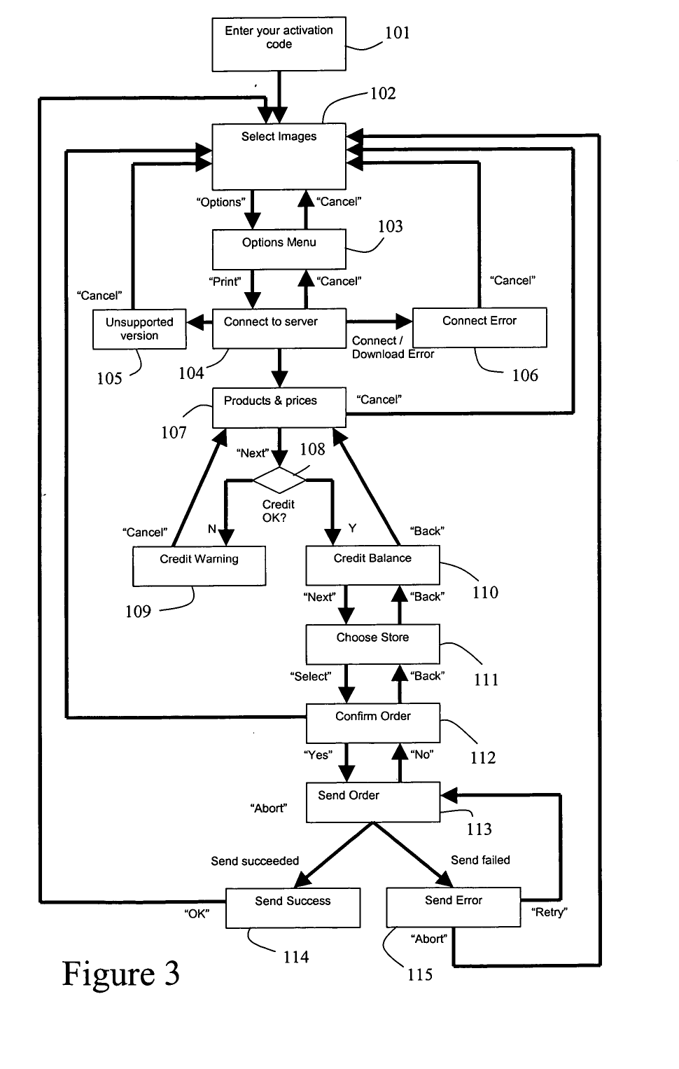

FIG. 3 illustrates the operation of the application running on the user's handset 2 and shows the various stages which will be apparent to the user when ordering prints of digital pictures. Where terms are shown in FIG. 3 in inverted commas, e.g. “Cancel”, this signifies that an option is made available to the user under that name, and the effect of choosing that option is shown by the arrow next to that term. Once the application has been downloaded and saved on the handset 2 it is activated by the user. The first time the application is run it requires an activation code 101 to be entered by the user.

The user then selects the images 102 to be printed, and confirms he wishes to proceed 103. The handset then initiates a connection to the server 104 as described above. If the version of the application is unsupported 105 or there is a connection error 106 then the user is informed of this and returned to the “select images” screen 102. Otherwise the products available to him (e.g. print size) are returned to and displayed on the handset 107.

The credit available to the user (if a registered account is mandatory) is calculated 108, and if not enough credit is available for the number and/or type of prints selected, the user is informed and returned to the product selection page 107. If there is sufficient credit 110 the user is informed of this and invited to select a store from which he wishes to collect his prints 111.

The screen for selecting a store is organised like the handset's telephone book, with a highlight bar showing the current position within the list. The server 5 sorts the store list by name into alphabetical order, meaning that the application running on the handset 2 does not need to do any sorting. On first display of the screen, the application checks the handset's persistent memory. If the user has placed a previous order their preferred store ID will have been saved. If a store ID is found, the application automatically scrolls the list to the relevant position, highlighting the user's preferred store.

Once the user has highlighted their pickup store, they choose “Select” which saves the user's preferred store to the handset's persistent memory and passes control to a “Confirm order” screen 112. It is possible that a user may have several brands of the application loaded on a single handset, and for this reason it must be possible to store a preferred Store ID for each individual service brand.

The user then confirms that the order is correct 112 and instructs 113 that it be sent to the print server 5. He is then returned to the initial “select images” page of the application following either a successful send operation 114 or failure 115.

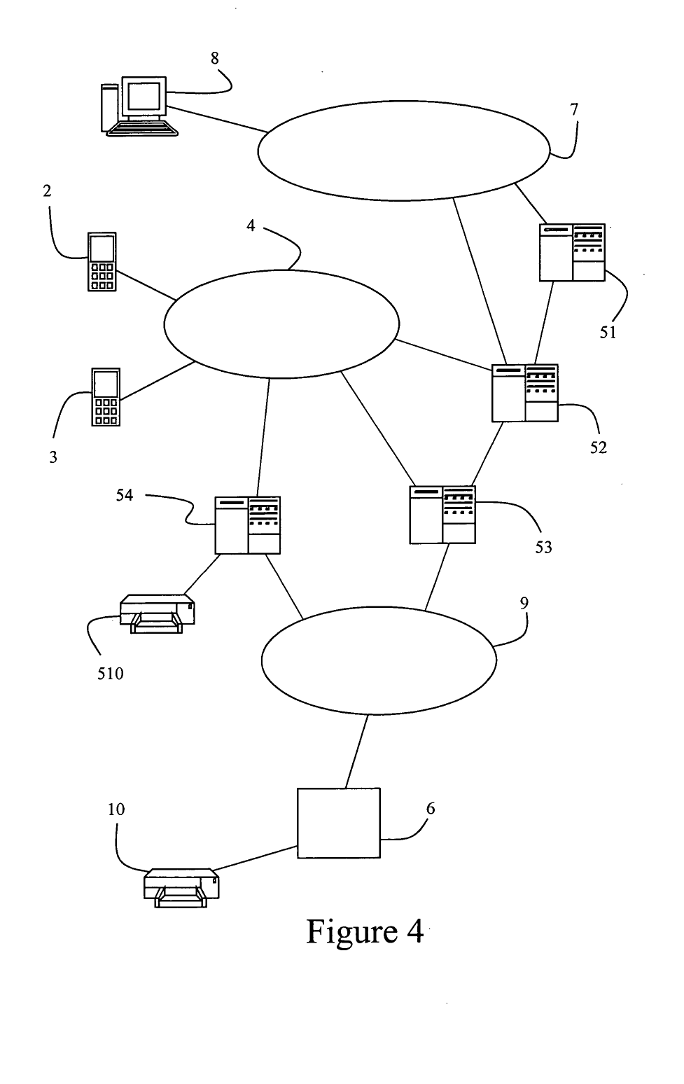

It will be appreciated that variations from the above described embodiment are possible which will still fall within the scope of the invention. For example, in the embodiment described, all operations performed remotely from the handset 2 are performed by a print server 5. It will be appreciated that in an alternative embodiment different operations may be performed by different servers. FIG. 4 shows an example of such a system, similar to FIG. 1, but having four separate servers 51, 52, 53, 54 in place of a single print server 5.

An account server 51 incorporates the account registration and maintenance module 11 shown in FIG. 2, and hosts the web pages used to enable the user to set up and maintain an account. An application server 52 incorporates the application deployment module 12, and can be accessed by a user over the Internet to initiate downloading of the application onto his handset 2. A configuration server 53 incorporates the handset order interface module 13, and is responsible for communicating with a handset 2 running the application, including supplying lists of participating stores. A printing server 54 is provided to incorporate the order processing module 14 and receive picture files from the handset to forward to the store 6 for printing. It is also possible for prints to be printed directly from the printing server via a printing apparatus 510 and sent either to a store for collection or directly to the user's home.

If different servers 51, 52, 53, 54 are provided to perform different operations, it enables a service to be provided by a single service provider for different retailers. For example, a retailer owning the store 6 could maintain the account server 51. The web pages hosted by the account server 51 would then be maintained by that retailer and the user would interact directly with them. Similarly, the application server 52 could be maintained by the retailer, and be configured to download a branded application specific to that retailer to the user's handset 2.

The configuration and printing servers 53, 54, could be operated by the service provider on behalf of a number of different retailers. Thus the retailers do not need to maintain the complex systems required to service print orders from a large number of users. Because the user interacts only with web pages on the account and application servers 51, 52, and receives an application branded to a specific retailer, it appears to him that he is dealing directly with that retailer at all times. There is thus a benefit to retailers who do not have the capacity to provide configuration and printing servers, but can appear to their customers to be receiving orders directly from them and printing them at their stores. A user can, of course, download branded applications from application servers 52 maintained by different retailers to give them access to more stores from which they can collect their prints.

Furthermore, it will be appreciated that other combinations of servers could be used. In another example the account registration 11 and application deployment 12 modules could be operated by one server, while the handset order interface 13 and order processing could be operated by a separate server. Other examples are also possible.

As a further refinement, an additional (unbranded) application could be installed on the user's handset 2. The additional application downloads from another server (not shown) a list of retailers offering the printing service. The list could be tailored to the user's location, based on his home address or the location of the handset, which may be entered by the user or obtained automatically. This enables the user to select a retailer with stores close to him from which prints may be collected. Once a retailer is selected, brand specific information such as icons, the available stores, products and prices and the retailer-specific application for ordering prints may be downloaded to the handset.

In addition, the embodiments described above make use of a GPRS or GSM core network. It will be appreciated that any suitable wireless network may be used. In particular, so-called third generation (3G) networks will use the Universal Mobile Telephony Services (UMTS) protocol, and the invention will work equally well using such networks.

In a further alternative, registration could be performed directly from the device rather than from a home computer over the Internet. This may be performed using the WAP capabilities of a handset 2 or by the handset application contacting the account server 51 directly.

Further alternatives for installation of the application on the handset 2 may also be envisaged. For example, rather than being downloaded from a server directly in response to an SMS message, the application could be installed via Bluetooth or infrared from a home computer or downloaded directly from a third party website. Other possibilities will be apparent to one skilled in the art.

1. A method of obtaining a printed copy of one or more digital picture files from a mobile wireless device, comprising:
selecting the one or more picture files to be printed;
downloading a list of options from a configuration server to the device;
selecting an option from the list of options; and
uploading an identification of the selected option and the selected picture files to a printing server.

2. The method of claim 1, further comprising running an application on the device, the application enabling the user to select the one or more picture files, download the list of options and upload the selected picture files to the printing server.

3. The method of claim 2, further comprising downloading the application to the device from an application server.

4. The method of claim 3, wherein the step of downloading the application to the device is performed in response to an initiation message from the application server.

5. The method of claim 4, further comprising causing the application server to transmit the initiation message by contacting the application server over the Internet to request the application.

6. The method of claim 3, further comprising supplying the telephone number of the device to the application server and downloading an activation code from the application server, the application server associating the activation code and user's telephone number.

7. The method of claim 6, further comprising entering the activation code the first time the application is run on the device.

8. The method of claim 7, wherein the printing server identifies the user from the activation code entered into the application.

9. The method of claim 2, further comprising installing the application on the device via Bluetooth or infrared from a computer.

10. The method of claim 1, further comprising supplying the telephone number of the device to the printing server.

11. The method of claim 1, further comprising supplying user identification to the printing server.

12. The method of claim 1, further comprising downloading a credit limit to the device from the configuration server and displaying the credit limit to the user.

13. The method of claim 1, further comprising downloading an account balance to the device from the configuration server and displaying the account balance to the user.

14. The method of claim 1, further comprising sending a confirmation message from the printing server to the device to confirm that the one or more picture files have been received by the printing server.

15. The method of claim 14, wherein the confirmation message is an SMS message.

16. The method of claim 1, wherein the step of downloading a list of options to the device from the configuration server includes downloading a list of stores from which the printed copies may be collected, and the step of selecting an option includes selecting a store.

17. The method of claim 16, further comprising printing copies of the selected picture files at the selected store.

18. The method of claim 16, further comprising printing copies of the selected picture files and sending them to the selected store.

19. The method of claim 17, further comprising sending a confirmation message to the device to inform the user that the printed copies are ready for collection from the selected store.

20. The method of claim 17, further comprising collecting the printed copies from the selected store.

21. The method of claim 1, further comprising downloading a service application onto the device and running the application, the service application operating to download a list of stores to the device, the list of stores being selected based on the location of the device.

22. The method of claim 21, further comprising selecting a store from the list of stores, printing copies of the selected picture files and collecting the printed copies from the selected store.

23. The method of claim 21, wherein the service application operates to download a list of one or more service providers to the device, each provider operating one or more stores, the list of retailers being selected based on the location of the device.

24. The method of claim 23, wherein a provider is selected from the list and information specific to that provider is downloaded to the device.

25. The method of claim 24, wherein the downloaded information includes a list of the stores operated by that provider.

26. The method of claim 1, wherein one of the options in the list of options includes sending the printed copies directly to an address provided by the user.

27. The method of claim 1, wherein the configuration server and the printing server are the same server.

28. The method of claim 1, wherein the step of uploading the picture files and identification of the selected option is performed using the General Packet Radio Service (GPRS) protocol.

29. The method of claim 1, wherein the step of uploading the picture files and identification of the selected option is performed using the Universal Mobile Telephony Services (UMTS) protocol.

30. A system for providing printed copies of digital picture files stored on mobile wireless devices, the system comprising:
a configuration server for receiving a printing request from a mobile wireless device and providing a list of printing options to the device;
a printing server for receiving one or more picture files from the device together with identification of one option selected from the list of printing options; and
a printing means for printing the one or more picture files in response to an instruction from the printing server.

31. The system of claim 30, wherein:
the list of printing options provided to the device includes a list of stores;
the option whose identification is provided to the printing server is a store selected from the list of stores; and
the printing means is arranged to provide the printed picture files to the selected store for collection by a user.

32. The system of claim 31, wherein the printing means is a printing apparatus attached to the selected store.

33. The system of claim 31, wherein files supplied by the configuration server to the device are branded so that it appears to the user to be operated by the provider of the stores in the list of stores.

34. The system of claim 30, further comprising an application server for uploading an application to the device, the application arranged when operated to:
enable the user to select one or more picture files;
cause the device to download the list of options from the configuration server;
enable the user to select one option from the list of options;
cause the device to send the selected picture files and identification of the selected option to the printing server.

35. The system of claim 30, further comprising a website enabling access to the application server via the Internet to cause the application to be uploaded to the device.

36. The system of claim 35, wherein a user is required to register before the application is uploaded to the device.

37. The system of claim 35, wherein the website is branded so that the user perceives that the prints are provided by the operator of the printing means.

38. The system of claim 30, wherein the configuration server and printing server are modules of the same server.
